(19) United States
(12) Patent Application Publication
(10) Pub. No.: US 2001/0052924 A1
(43) Pub. Date: Dec. 20, 2001

(54) Method and device for integrated laser and UV exposure of printing plates

(76) Inventors: Dirk Steinke, Mielkendorf (DE); Jorg-Achim Fischer, Kiel (DE); Thomas Jacobsen, Kiel (DE)

Correspondence Address: LERNER AND GREENBERG, P.A., Post Office Box 2480, Hollywood, FL, 33022-2480, US

(21) Appl. No.: 09/861,430

(22) Filed: May 18, 2001

(30) Foreign Application Priority Data
May 18, 2000 (DE) 100 24 456.4

(51) Int. Cl. B41J 2/47

(52) U.S. Cl. 347/225

(57) ABSTRACT

The printing plate has a carrier layer, a photopolymer layer and a laser-sensitive layer, in particular, a flexographic printing plate for direct laser exposure. The laser-sensitive layer is firstly selectively removed in a laser exposure unit with a laser beam that is moved relative to the printing plate, and the printing plate is subsequently irradiated with UV light at least on the side of the selectively removed laser-sensitive layer. This prevents washing out of the photopolymer layer under the removed regions of the laser-sensitive layer during subsequent developing of the printing plate. Time required for the partial removal of the laser-sensitive layer and the irradiation with UV light and to lower the space requirement and investment costs, different regions of the plate are irradiated with laser beam and with the UV light simultaneously in the laser exposure unit.

### BACKGROUND OF THE INVENTION

1. Field of the Invention

The invention lies in the printing technology field. More specifically, the invention relates to the production of printing plates, in particular flexographic printing plates, and concerns a method and a device for transferring information to a printing plate, in particular to a flexographic printing plate, for direct laser exposure. The invention pertains, further, to a laser exposure unit for printing plates of this type.

Flexographic printing plates for direct laser exposure usually comprise a lower carrier layer of polyester or some other flexible plastic material, a middle “photopolymer” layer, containing unsaturated monomers and elastomeric binders, which are crosslinked when exposed to UV light and thereby prevent subsequent washing out during developing, and also an upper laser-sensitive layer, which is partially removed by irradiating with laser light in predetermined regions that correspond to the information to be transferred, in order to produce over the photopolymer layer a mask integrally bonded to the printing plate. During subsequent UV exposure of the printing plate, this mask covers those regions of the photopolymer layer at which the laser-sensitive layer has not previously been removed and prevents crosslinking or curing of the photopolymer layer in these regions, so that during subsequent developing of the printing plate it is washed out there by the developer. The fully developed printing plate has raised and recessed regions, the former being arranged where the laser-sensitive layer has previously been removed by the irradiation with the laser light.

In known methods of direct laser exposure of flexographic printing plates, the entire printing plate is firstly scanned in a laser exposure unit by one or more laser beams in order to remove the laser-sensitive layer in the subsequent printing regions of the printing plate in a punctiform manner respectively corresponding to a predetermined halftone screen. For this purpose, the printing plate is usually mounted onto a drum of the laser exposure unit, along which an optical laser beam scanning system is moved line by line in the axial direction, the drum being rotated by a predetermined angular amount after each scanning of one or more lines, so that the next line or lines can be scanned. After completion of the mask, the printing plate is removed from the drum of the laser exposure unit and irradiated over a large surface area with diffuse UV light in a UV exposure unit in order to crosslink and cure the non-masked regions of the photopolymer layer.

In the known method, the relatively large time requirement for removing the printing plate from the drum of the laser exposure unit and transporting it to the UV exposure unit is regarded as disadvantageous, while the relatively great space requirement and not inconsiderable investment costs with regard to the required equipment, i.e. the laser exposure unit and the UV exposure unit, are regarded as disadvantageous.

### SUMMARY OF THE INVENTION

The object of the present invention is to provide a method and a device for transferring information onto a printing plate which overcomes the above-noted deficiencies and disadvantages of the prior art devices and methods of this general kind, and which reduces the time required for the partial removal of the laser-sensitive layer and the irradiation with UV light in these methods and devices and to lower the space requirement and investment costs for the equipment that is required.

With the above and other objects in view there is provided, in accordance with the invention, a method of transferring information to a printing plate, in particular a flexographic printing plate for direct laser exposure. The plate has a carrier layer, a photopolymer layer, and a laser-sensitive layer. The method comprises the following steps:

exposing the printing plate to a laser beam, moving the laser beam with respect to the printing plate, and selectively removing portions of the laser-sensitive layer with the laser beam;

irradiating the printing plate with UV light at least on a side of the selectively removed laser-sensitive layer, and thereby preventing washing out of the photopolymer layer beneath the removed portions of the laser-sensitive layer during subsequent developing of the printing plate;

and thereby simultaneously irradiating different regions of the surface of the printing plate with the laser beam and with the UV light.

With the above and other objects in view there is also provided, in accordance with the invention, a device for transferring information to a printing plate of the type having a carrier layer, a photopolymer layer, and a laser-sensitive layer. The device comprises:

a laser exposure unit with a printing plate carrier and at least one laser beam that can be moved with respect to the printing plate carrier and scans the printing plate for selectively removing portions of the laser-sensitive layer;

at least one UV light source for irradiating the printing plate at the selectively removed laser-sensitive layer with UV light, the at least one UV light source being disposed to subject the photopolymer layer to UV light in the laser exposure unit.

There is also provide, in accordance with the invention, a laser exposure unit for transferring information to a printing plate of the type having a carrier layer, a photopolymer layer, and a laser-sensitive layer, comprising a printing plate carrier and a laser light source configured to generate a movable laser beam scanning a surface of a printing plate disposed on the printing plate carrier for selectively removing the laser-sensitive layer, and at least one UV light source for producing a UV light patch on the selectively removed laser-sensitive layer following the scanning of the surface of the printing plate with the laser beam.

The invention is based on the idea of not having to wait, as in the past, until the laser-sensitive layer has been scanned by the laser beam over the entire surface of the printing plate before carrying out the UV exposure but to begin the UV exposure while this operation is still in progress, to be precise to begin it in those regions of the surface of the printing plate in which the laser-sensitive layer has already been removed by the laser beam. According to a first aspect of the invention, the removal of the laser-sensitive layer and the irradiation with UV light consequently takes place simultaneously in different regions of the surface of the printing plate, and preferably progressively in the same unit, expediently a modified laser exposure unit, which according to a further aspect of the invention is equipped with an additional UV light source, from which the surface of the printing plate, after having been scanned with the laser beam, is irradiated successively portion by portion with UV light in order to crosslink the photopolymer layer under the regions of the laser-sensitive layer removed shortly before, or make them resistant to subsequent washing out.

In this case, it is possible in principle to move a light spot produced by the laser beam or a plurality of light spot produced simultaneously by a plurality of laser beams, and also a UV light patch produced by the irradiation with UV light on the surface of the printing plate or possibly also a plurality of UV light patchs produced next to one another or at a distance from one another independently of one another over the surface of the printing plate. However, a preferred embodiment of the invention envisages moving a laser printing head, serving for scanning the surface of the printing plate with laser light, and moving a UV printing head, serving for scanning the surface of the printing plate with UV light, along the surface of the printing plate at the same speed and at a predetermined distance from it.

According to a further preferred embodiment of the invention, the printing plate is mounted in the laser exposure unit onto a drum, and the laser printing head and the UV printing head are moved on a common slide or two separate slides line by line in the axial direction along the drum, which is rotated further by a predetermined angular amount each time the exposure of one or more lines with the laser light and with the UV light is completed in order to scan the next line or the next lines with the laser light or with the UV light.

If the laser printing head and the UV printing head are moved together over the surface of the printing plate, the two printing heads are preferably arranged at a predetermined distance from each other either in the axial direction or in the circumferential direction of the drum. While in the case mentioned first the UV light patch is moved in the axial direction behind the laser light spot successively over one or more entire lines before the drum is rotated further and the next line or lines are exposed with the laser beam and with the UV light, in the case mentioned last the UV exposure of one or more lines is begun only after their complete scanning with the laser beam, when the drum has been rotated further to such an extent that the UV printing head passes over these one or more lines.

In a line-by-line scanning of the printing plate with one or more laser beams, the width of the subsequent UV light patch, i.e. its dimension transversely to its direction of movement, is expediently chosen such that it corresponds to the scanning width of the laser printing head or exceeds the latter somewhat, in order in this way to ensure a uniform light intensity over the entire width of one or more scanning lines. The length of the UV light patch is preferably set in accordance with the light intensity of the emitted UV light such that, when the UV light patch passes over it, the photopolymer layer is completely crosslinked under a region of the laser-sensitive layer removed just before, and consequently additional subsequent UV exposure becomes superfluous.

On a printing plate mounted onto a drum, the length of the UV light patch is expediently not greater than the difference between the length of the drum and the length of the printing plate in the axial direction of the drum, so that it is not necessary to move the laser printing head or the UV printing head beyond the end of the drum in order to expose the edges of the printing plate with UV light or scan them with the laser beam.

The laser printing head and/or the UV printing head may be equipped with one or more laser light sources, for example a single-beam YAG laser, a multi-beam YAG laser or a laser-diode array or else with one or more UV light sources, for example one or more deuterium lamps, which are guided along the surface of the printing plate on a slide, an optical system arranged between the UV light source and the surface of the printing plate forming the UV light into a light spot of the desired size, it being possible for the result of the UV exposure to be influenced in a specific way by an optical system of an appropriate design.

As an alternative to this, however, at least the UV light source and possibly also the laser light source may be stationarily arranged and connected to the respective printing head by means of a fiber-optic light guide in order to reduce the masses to be moved.

The fiber-optic light guides used for the transmission of the UV light are preferably liquid fiber-optic light guides, which transmit the UV light through a highly transparent liquid enclosed inside them, while glass or plastic fiber-optic light guides are preferably used for the transmission of the laser light.

Since the flexographic printing plates currently used also have to be exposed from their rear side with UV light before they are developed, in the case of these printing plates the time and space requirement necessary for development can be further reduced if, according to a further preferred embodiment of the invention, the plates are placed or mounted onto a printing plate carrier that is transparent to UV light and their rear side is exposed to UV light through this carrier. The exposure of the rear side may take place while the front side of the plate is being scanned by the laser beam and exposed with UV light, or directly thereafter. During the exposure of the rear side, the entire rear side of the printing plate can be exposed simultaneously, for example by means of a diffuse UV light source which irradiates the entire side of the printing plate carrier facing away from the printing plate simultaneously with UV light, or gradually, the rear side of the printing plate, like its front side, preferably being scanned with a UV light patch line by line and column by column. For exposing the rear side of a printing plate mounted on a drum of a laser exposure unit, the drum may comprise a hollow cylinder that is transparent to UV light, which is provided inside with a UV light source or can be subjected to UV light from the inside via a UV light guide.

In the exposure of the rear side, the power of the UV light is controlled in such a way that it does not reach the region exposed on the front side, in order not to destroy the information transmitted to the printing plate by the irradiation with the laser beam and the exposure of the front side. That is to say that the intensity of the exposure of the rear side is adjusted to the material of the printing plate in such a way that the depth of penetration is only relatively small and suffices to prevent washing out of the printing plate material during the subsequent developing of the printing plate on its rear side.

Other features which are considered as characteristic for the invention are set forth in the appended claims.

Although the invention is illustrated and described herein as embodied in an integrated laser and UV exposure of printing plates, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### DESCRIPTION OF THE PREFERRED EMBODIMENTS

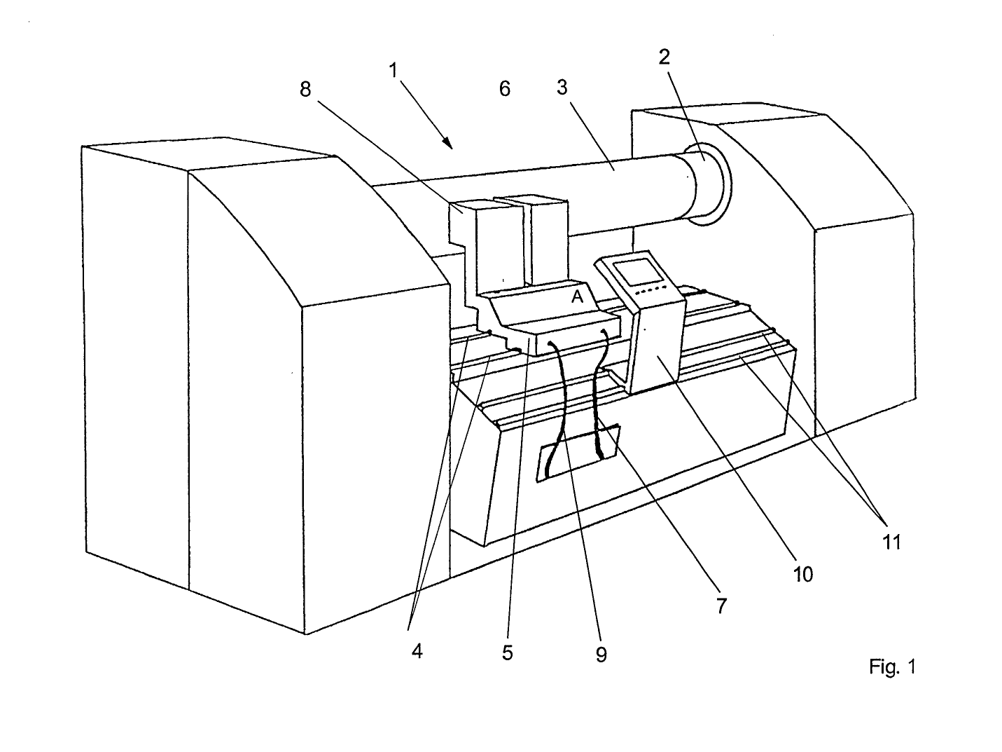

FIG. 1 is a simplified perspective view of a laser exposure unit according to the invention;

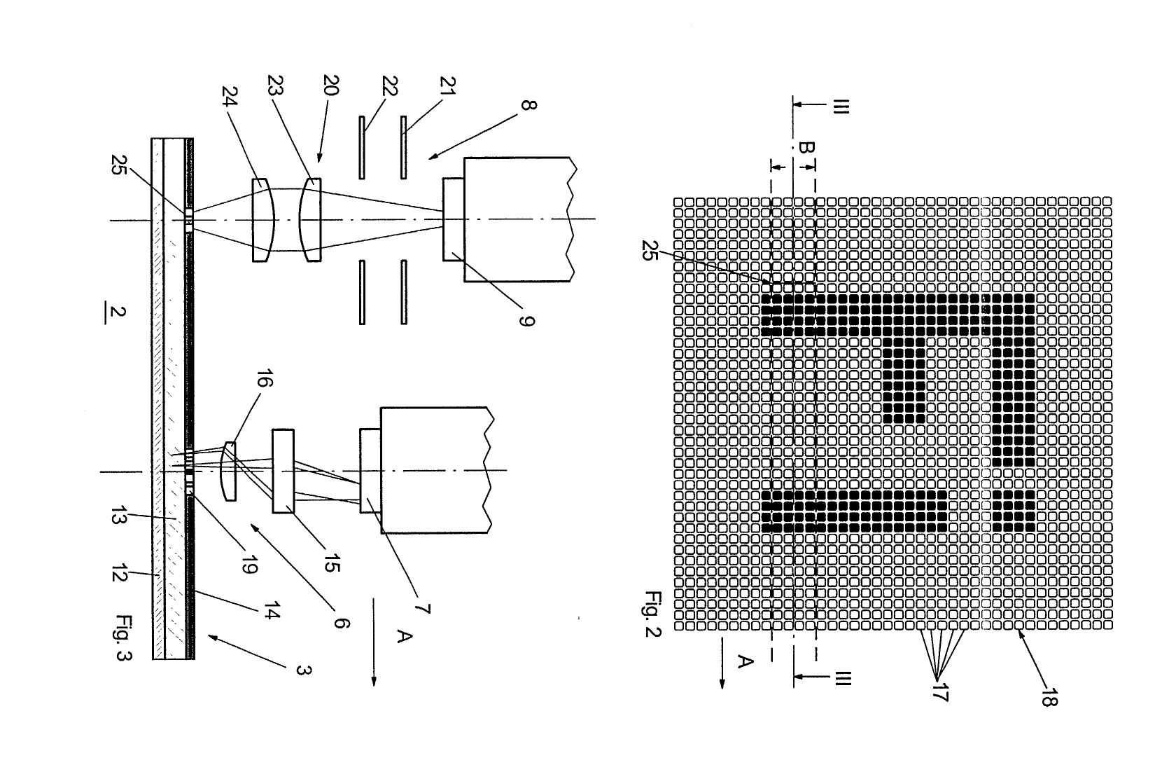

FIG. 2 is a schematic plan view onto a part of a flexographic printing plate mounted in the laser exposure unit;

FIG. 3 is a diagrammatic cross-sectional view of the printing plate and parts of the laser exposure unit along the line III-III of FIG. 2;

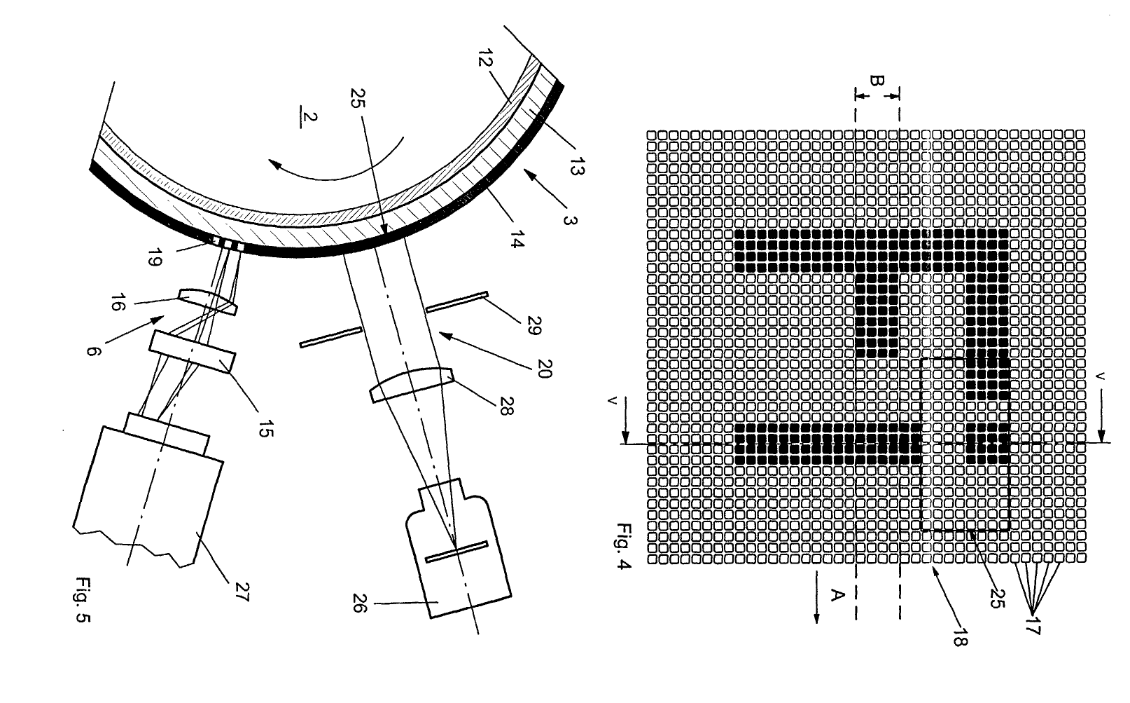

FIG. 4 shows a view corresponding to FIG. 2 for explaining a somewhat modified method according to the invention; and

FIG. 5 is a diagrammatic sectional view of the printing plate and parts of a somewhat modified laser exposure unit along the line V-V of FIG. 4.

### DESCRIPTION OF THE PREFERRED EMBODIMENTS

Referring now to the figures of the drawing in detail and first, particularly, to FIG. 1 thereof, there is seen a laser exposure unit 1 that serves for the direct exposure of flexographic printing plates. The device comprises a drum 2 which is rotatably mounted between two lateral parts of the exposure unit and on the circumferential surface of which the flexographic printing plates 3 to be exposed are mounted, a non-illustrated rotary drive for rotating the drum 2 and the printing plates 3, a slide 5, which can be moved on guides 4 in the axial direction of the drum 2 and of the mounted printing plate 3, a laser printing head 6, which is mounted on the slide 5 and is connected by a fiber-optic light guide 7 to a stationary laser light source, for example a multi-beam YAG laser, not visible in a lower part of the exposure unit, a UV printing head 8, which is mounted on the slide 5 and is connected by a further fiber-optic light guide 9 to a stationary UV light source not visible in the lower part of the exposure unit, and also a control console 10, which is likewise movable on guides 11 along the drum 2 in the axial direction.

While a conventional fiber-optic light guide 7, the fibers of which consist of sheathed quartz or plastic, is used for the transmission of the laser radiation, the fiber-optic light guide 9 used for the transmission of the UV radiation comprises fibers filled with liquid, for example the liquid light guides of the series 250 available from LUMATECH, Munich, Germany, which have a lower power loss than conventional quartz fibers during transmission in the desired wavelength range of 315 to 380 nm.

With reference to FIGS. 3 and 5, the commercially available flexographic printing plate 3 that is mounted on the drum 2 for direct laser exposure essentially comprises a lower substrate or carrier layer 12 of metal or plastic, preferably a polyester film, a photopolymer layer 13 applied to the upper side of the carrier layer 12, containing unsaturated monomers and elastomeric binders, which are crosslinked when exposed to UVA light at a wavelength of 315 to 380 nm to form longchained polymers, and a laser-sensitive layer 14 that is opaque to UV radiation. The laser-sensitive layer 14 is applied to the surface of the photopolymer layer 13.

The laser printing head 6 which can be moved along the surface of the drum in the axial direction and the construction of which is schematically represented in FIG. 3 is designed as an N-channel multi-beam printing head and essentially comprises a light switch 15 for the selective interruption of the individual laser beams in a way corresponding to the image information to be transmitted, and also a lens 16 for focusing the laser beams which are arranged between the end of the fiber-optic light guide 7 and the surface of the printing plate 3. The light switch 15 is controlled by a non-illustrated raster image processor RIP of the laser exposure unit 1, which breaks down the text and/or image data to be transmitted to the printing plate 3 into individual digital pixel data and opens or closes the light switch 15 in a way that corresponds to these pixel data. From the laser printing head 6, a plurality of high-intensity laser beams can be emitted simultaneously onto the surface of the printing plate 3, a plurality of lines 17 running in the axial direction of the drum 2 of a dot screen 18 to be transmitted onto the printing plate, represented in a simplified form in FIGS. 2 and 4, being scanned simultaneously. In this case, the laser-sensitive layer 14 is removed at the points exposed by the laser beam, these points corresponding to the dots represented in black in FIGS. 2 and 4, to which printing ink is to be transferred during the subsequent printing operation. The partial removal of the laser-sensitive layer 14 concerns a type of micro-cutting operation, a purely physical, thermal process in which the laser-sensitive layer 14 is removed in a way corresponding to the predetermined dot screen with the formation of punctiform openings 19 as far as the photopolymer layer 13. The wavelength of the laser radiation emitted by the laser light source lies in the infrared range, while the photopolymer is sensitive in the UV range, so that during scanning with the laser light said photopolymer is not influenced by the latter.

The UV printing head 8 mounted behind the laser printing head 6 in the direction of movement of the slide 5 arrow A in FIG. 2 serves the purpose of irradiating the surface of the printing plate with UV light directly after the exposure with the laser light. This UV light penetrates through the punctiform openings 19, formed shortly before, into the photopolymer layer 13, the monomers of the photopolymer beneath these openings 19 being crosslinked, so that the photopolymer is not washed out during subsequent washing of the printing plate 3 in the course of being developed at these locations. This is in contrast with the regions in which the laser-sensitive layer 14 opaque to UV radiation is preserved. There, no crosslinking of the monomers takes place as a consequence.

The UV printing head 8 schematically represented in FIG. 3 essentially comprises an optical system 20 which is arranged between the end of the fiber-optic light guide 9 and the surface of the printing plate 3 and may comprise, for example, one or more diaphragm elements 21, 22 and/or one or more lens elements 23, 24, in order to produce on the surface of the printing plate 3 a UV irradiation area, here referred to as a light patch 25, which is preferably sharply outlined and has an essentially uniform intensity distribution.

In the exemplary embodiment represented in FIGS. 2 and 3, the UV light patch 25 has a square outline and has in the circumferential direction of the drum 2 a width corresponding to the scanning with B of the laser printing head 6, so that each point on the surface of the printing plate 3 is passed over by the UV light patch 25 a single time.

By contrast, the UV light patch 25 represented in FIGS. 4 and 5 has a rectangular shape, with a width corresponding to twice the scanning with B of the laser printing head 6 and a greater length, in the example represented twice its width, so that each point of the surface of the printing plate is passed over twice by the UV light patch 25 and exposure also takes place longer in each individual scanning line 17 or group of scanning lines 17. As a result, the energy density of the UV radiation emitted by the UV light source can be reduced without influencing the required specific energy density of approximately 20 Ws/cm² of printing plate surface area.

By contrast with the exemplary embodiment of FIGS. 1 to 3, the UV printing head 8 in the exemplary embodiment represented in FIGS. 4 and 5 is not arranged behind the laser printing head 6 in the axial direction but in the direction of rotation of the drum 2, is moved however together with said printing head in the axial direction of the drum 2, so that groups of scanning lines 17 arranged there at a distance one above the other are subjected to the laser radiation or to the UV radiation simultaneously at essentially the same axial location, while in FIGS. 2 and 3 a single group of a plurality of neighboring scanning lines 17 and two locations arranged at an axial distance apart are subjected simultaneously to the laser radiation or to the UV radiation.

In the exemplary embodiment represented in FIG. 5, both a laser radiation source in the form of a multi-line laser-diode array 27 and a UV radiation source in the form of a deuterium lamp 26 are also mounted on the slide 5 itself, this lamp 26 producing UV light in a continuum of 175 to 300 nm. The optical system 20 arranged between the lamp 26 and the surface of the printing plate is likewise differently constructed and comprises only one lens element 28 and one diaphragm element 29. As can be seen from a comparison of FIGS. 3 and 5, the choice of a suitable optical system 20, which instead of or in addition to lenses or diaphragms may comprise other optical elements, allows not only the shape or size of the UV light patch 25 to be influenced but also other properties of the UV radiation, such as for example its focusing or coherence, and consequently the result of the UV exposure, by contrast with the known UV exposure units, in which the entire surface of the printing plate is flooded with diffuse UV light.

For the exposure of the rear side of the printing plate 3 with UV light, resting on the drum 2, the drum 2 is produced as a hollow cylinder from a material that is transparent to UV light, such as quartz glass, and contains in its hollow interior a non-illustrated UV light source, for example a cylindrical UV light source, with which the printing plate 3 can be irradiated uniformly with UV light through the wall of the drum 2 for the exposure of the rear side.

We claim:

1. A method of transferring information to a printing plate of the type having a carrier layer, a photopolymer layer, and a laser-sensitive layer, which comprises:
exposing the printing plate to a laser beam, moving the laser beam with respect to the printing plate, and selectively removing portions of the laser-sensitive layer with the laser beam;
irradiating the printing plate with UV light at least on a side of the selectively removed laser-sensitive layer, and thereby preventing washing out of the photopolymer layer beneath the removed portions of the laser-sensitive layer during subsequent developing of the printing plate;
and thereby simultaneously irradiating different regions of the surface of the printing plate with the laser beam and with the UV light.

2. The method according to claim 1, wherein the exposing step comprises moving at least one laser beam over the surface of the printing plate, and scanning the surface with at least one laser light spot.

3. The method according to claim 1, wherein the irradiating step comprises moving at least one UV light beam over the surface of the printing plate, and scanning the surface with at least one UV light patch.

4. The method according to claim 1, wherein the exposing step comprises moving at least one laser beam over the surface of the printing plate, and scanning the surface with at least one laser light spot, the irradiating step comprises moving at least one UV light beam over the surface of the printing plate, and scanning the surface with at least one UV light patch, and thereby causing the UV light patch to follow the laser light spot substantially at a predetermined distance over the surface of the printing plate.

5. The method according to claim 4, which comprises setting a size of the UV light patch to at least a size of the laser light spot.

6. The method according to claim 1, wherein the exposing step comprises moving at least one laser beam over the surface of the printing plate, and scanning the surface with at least one laser light spot, the irradiating step comprises moving at least one UV light beam over the surface of the printing plate, and scanning the surface with at least one UV light patch, and thereby causing the UV light patch to follow the laser light spot independently of a movement of the laser light spot over the surface of the printing plate.

7. The method according to claim 6, which comprises setting a size of the UV light patch to at least a size of the laser light spot.

8. The method according to claim 1, which comprises scanning the printing plate line by line with the laser beam and with the UV light.

9. The method according to claim 7, which comprises simultaneously scanning a plurality of lines of the printing plate with the laser beam, and setting a width of an area of the printing plate irradiated with the UV light to correspond at least to a width of the plurality of laser beam scanning lines.

10. The method according to claim 1, which comprises placing the printing plate onto a printing plate carrier and not removing the printing plate from the printing plate carrier between exposing and irradiating steps.

11. The method according to claim 1, which comprises, for the irradiating and exposing steps, placing the printing plate onto a printing plate carrier that is transparent to UV light and, during or after irradiation of a front side of the printing plate with the laser beam and the UV light, irradiating a rear side of the printing plate with UV light through the printing plate carrier.

12. The method according to claim 1, which comprises providing the printing plate in the form of a flexographic printing plate for direct laser exposure.

13. A device for transferring information to a printing plate of the type having a carrier layer, a photopolymer layer, and a laser-sensitive layer, the device comprising:
a laser exposure unit with a printing plate carrier and at least one laser beam that can be moved with respect to said printing plate carrier and scans the printing plate for selectively removing portions of the laser-sensitive layer;
at least one UV light source for irradiating the printing plate at the selectively removed laser-sensitive layer with UV light, said at least one UV light source being disposed to subject the photopolymer layer to UV light in said laser exposure unit.

14. The device according to claim 13, wherein said laser exposure unit is configured to allow different regions of the surface of the printing plate to be subjected to one of the laser beam and the UV light simultaneously in said laser exposure unit.

15. The device according to claim 13, wherein the UV light is movable in the form of a UV light patch over the surface of the printing plate.

16. The device according to claim 13, wherein said at least one UV light source is mounted in said laser exposure unit.

17. The device according to claim 13, which further comprises a light guide disposed to transmit the UV light from said UV light source into a vicinity of the surface of the printing plate.

18. The device according to claim 17, which comprises an optical system disposed between an outlet end of said UV light guide and the surface of the printing plate for influencing radiation properties of the UV light.

19. The device according to claim 13, which comprises an optical system disposed between said UV light source and the surface of the printing plate for influencing radiation properties of the UV light.

20. The device according to claim 13, wherein said printing plate carrier is a rotatable drum and said UV light source is adapted to project a UV light patch movable in an axial direction of said drum over the surface of the printing plate.

21. The device according to claim 20, which further comprises a slide movably disposed with respect to said drum, and wherein one of said UV light source and an outlet end of a UV light guide connected to said UV light source is fitted on said slide.

22. The device according to claim 21, wherein said slide carries said laser light source.

23. The device according to claim 22, wherein one of said UV light source and an outlet end of a UV light guide is arranged behind said laser light source in a direction of movement of said slide.

24. The device according to claim 21, wherein said slide carries an outlet end of a laser light guide connected to said laser light source.

25. The device according to claim 24, wherein one of said UV light source and an outlet end of a UV light guide is arranged behind the outlet end of said laser light guide in a direction of movement of said slide.

26. The device according to claim 13, wherein said UV light source is configured to pass the UV light patch over the surface of the printing plate a single time.

27. The device according to claim 13, wherein said UV light source is configured to pass the UV light patch over the surface of the printing plate a plurality of times.

28. The device according to claim 13, wherein a sum of the energy densities of the UV light patch moved over the surface of the printing plate is at least substantially 20 Ws per cm² of printing plate surface area.

29. The device according to claim 13, wherein said printing plate carrier is transparent to UV light, and a UV light source is arranged on a side of said printing plate carrier facing away from the printing plate.

30. A laser exposure unit for transferring information to a printing plate of the type having a carrier layer, a photopolymer layer, and a laser-sensitive layer, comprising a printing plate carrier and a laser light source configured to generate a movable laser beam scanning a surface of a printing plate disposed on said printing plate carrier for selectively removing the laser-sensitive layer, and at least one UV light source for producing a UV light patch on the selectively removed laser-sensitive layer following the scanning of the surface of the printing plate with the laser beam.
